(19) United States
(12) Patent Application Publication
(10) Pub. No.: US 2009/0274594 A1
(43) Pub. Date: Nov. 5, 2009

(54) METHODS AND SYSTEMS FOR FEED INJECTOR MULTI-COOLING CHANNEL

(76) Inventors: Cliff Yi Guo, Sugarland, TX (US); Shashishekara Sitharamarao Talya, Houston, TX (US); Scott R. Parent, Houston, TX (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/112,177

(22) Filed: Apr. 30, 2008

(51) Int. Cl. B01J 7/00; F28D 7/00; B01J 19/14

(52) U.S. Cl. 422/200

(57) ABSTRACT

Methods and systems for a feed injector are provided. The feed injector includes a conduit including a flow passage extending along a longitudinal axis of the conduit to a distal end opening and a cooling passage integral to the conduit circumscribing the distal end opening. The cooling passage is configured to channel a flow of coolant circumferentially about the distal end opening wherein the cooling passage comprising a plurality of axially-spaced flow chambers.

### BACKGROUND

This invention relates generally to combined cycle power systems and more specifically, to methods and apparatus for cooling a feed injector.

At least some known combined cycle power systems used for power generation include a gasification system that is integrated with at least one power-producing turbine system. For example, known gasifiers convert a mixture of fuel, air or oxygen, steam, and/or limestone into an output of partially oxidized gas, sometimes referred to as “syngas.” Syngas is supplied to the combustor of a gas turbine engine, which powers a generator that supplies electrical power to a power grid. Exhaust from at least some known gas turbine engines is supplied to a heat recovery steam generator that generates steam for driving a steam turbine. Power generated by the steam turbine also drives an electrical generator that provides additional electrical power to the power grid.

At least some known gasification systems use at least one feed injector to supply fuel into a reactor vessel coupled within the gasification system. Known feed injectors are exposed to temperature extremes within the reactor vessel. Specifically, the tips of known feed injectors are exposed to reaction temperatures that may inhibit effective operation of the feed injectors and/or shorten the life span of the feed injectors. Additionally, known feed injectors are also exposed to corrosive elements in the syngas flowing within the reactor vessel. Over time, exposure to such elements may adversely affect the operation and/or shorten the life span of known feed injectors.

To facilitate preventing damage to the feed injectors, at least some known gasification systems use a closed-loop water system to supply cooling water to the feed injector. However, the cooling systems are not integral to the feed injector and the separation between the cooling system and the injector permits thermal damage to the injector.

### SUMMARY

In one embodiment, a feed injector are includes a conduit including a flow passage extending along a longitudinal axis of the conduit to a distal end opening and a cooling passage integral to the conduit circumscribing the distal end opening. The cooling passage is configured to channel a flow of coolant circumferentially about the distal end opening wherein the cooling passage comprising a plurality of axially-spaced flow chambers.

In another embodiment, a method of cooling an injector tip includes supplying a flow of coolant to a first flow chamber formed in the injector tip, channeling the flow of coolant through a plurality of axially-aligned radially-spaced coolant passes formed in the first flow chamber, and channeling the flow of coolant through an axially-spaced second flow chamber.

In yet another embodiment, a gasifier includes a pressure vessel and a feed injector extending through the pressure vessel. The feed injector includes a nozzle tip at a distal end of the feed injector. The feed injector further includes an integral cooling passage circumscribing the distal end opening wherein the cooling passage is configured to channel a flow of coolant circumferentially about the distal end opening. The cooling passage includes at least a first, a second, and a third axially-spaced flow chambers.

### BRIEF DESCRIPTION OF THE DRAWINGS

FIG. 1 is a schematic diagram of an exemplary combined cycle power system in accordance with an embodiment of the invention;

FIG. 2 is a schematic side view of an exemplary gasifier that may be used with the combined cycle power system shown in FIG. 1;

FIG. 3 is a side cross-sectional view of an exemplary embodiment of the feed injector shown in FIG. 2;

FIG. 4 is a plan view of the feed injector taken along line A-A shown in FIG. 3;

FIG. 5 is a plan view of the feed injector taken along line B-B shown in FIG. 3; and

FIG. 6 is a plan view of the feed injector taken along line C-C shown in FIG. 3.

### DETAILED DESCRIPTION

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to a preferred embodiment, namely, providing multi-channel cooling to a feed injector to improve system performance. However, it is contemplated that this disclosure has general application to piping systems and piping system components in industrial, commercial, and residential applications.

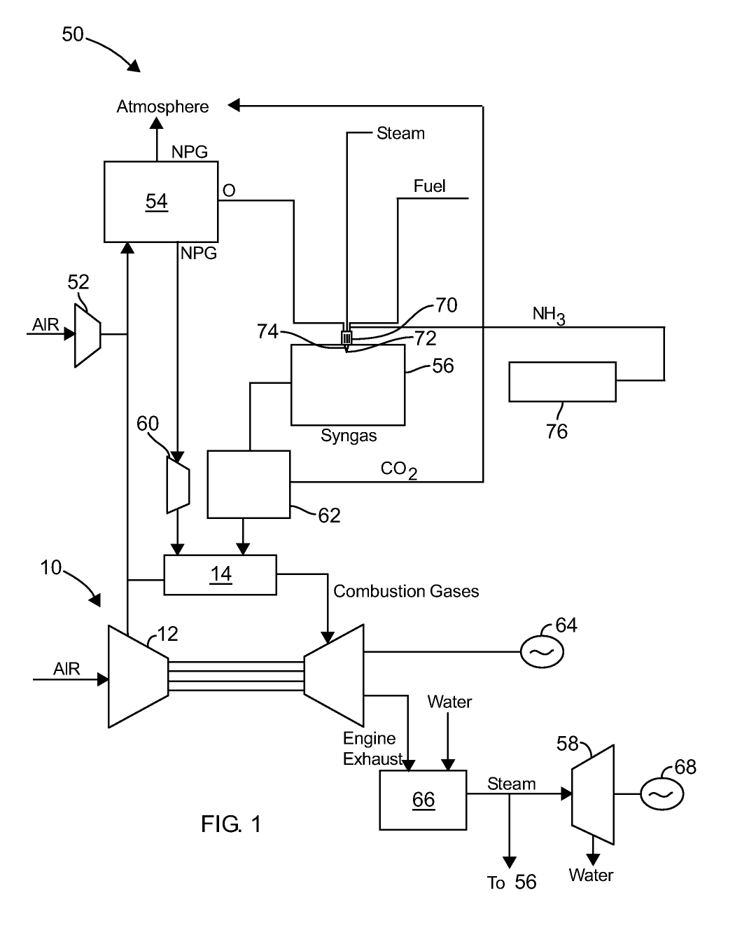

FIG. 1 is a schematic diagram of an exemplary known combined-cycle power system 50. System 50 generally includes a main air compressor 52, an air separation unit 54 coupled in flow communication to compressor 52, a gasifier 56 coupled in flow communication to air separation unit 54, a gas turbine engine 10, coupled in flow communication to gasifier 56, and a steam turbine 58.

In operation, compressor 52 compresses ambient air that is channeled to air separation unit 54. In some embodiments, in addition to compressor 52 or alternatively, compressed air from gas turbine engine compressor 12 is supplied to air separation unit 54. Air separation unit 54 uses the compressed air to generate oxygen for use by gasifier 56. More specifically, air separation unit 54 separates the compressed air into separate flows of oxygen (O₂) and a gas by-product, sometimes referred to as a “process gas.” The process gas generated by air separation unit 54 includes nitrogen and will be referred to herein as “nitrogen process gas” (NPG). The NPG may also include other gases such as, but not limited to, oxygen and/or argon. For example, in some embodiments, the NPG includes between about 95% and about 100% nitrogen. The O₂ flow is channeled to gasifier 56 for use in generating partially oxidized gases, referred to herein as “syngas” for use by gas turbine engine 10 as fuel, as described below in more detail. In some known systems 50, at least some of the NPG flow is vented to the atmosphere from air separation unit 54. Moreover, in some known systems 50, some of the NPG flow is injected into a reaction zone (not shown) within gas turbine engine combustor 14 to facilitate controlling emissions of engine 10, and more specifically to facilitate reducing the combustion temperature and reducing nitrous oxide emissions from engine 10. In the exemplary embodiment, system 50 includes a compressor 60 for compressing the nitrogen process gas flow before being injected into the reaction zone.

Gasifier 56 converts a mixture of fuel, O₂ supplied by air separation unit 54, steam, and/or limestone into an output of syngas for use by gas turbine engine 10 as fuel. Although gasifier 56 may use any fuel, in some known systems 50, gasifier 56 uses coal, petroleum coke, residual oil, oil emulsions, tar sands, and/or other similar fuels. In some known systems 50, the syngas generated by gasifier 56 includes carbon dioxide. In the exemplary embodiment, syngas generated by gasifier 52 is cleaned in a clean-up device 62 before being channeled to gas turbine engine combustor 14 for combustion thereof. Carbon dioxide (CO₂) may be separated from the syngas during clean-up and, in some known systems 50, may be vented to the atmosphere. Gas turbine engine 10 drives a generator 64 that supplies electrical power to a power grid (not shown). Exhaust gases from gas turbine engine 10 are channeled to a heat recovery steam generator 66 that generates steam for driving steam turbine 58. Power generated by steam turbine 58 drives an electrical generator 68 that provides electrical power to the power grid. In some known systems 50, steam from heat recovery steam generator 66 is supplied to gasifier 56 for generating syngas.

Furthermore, in the exemplary embodiment, system 50 includes a pump 70 that supplies steam 72 from steam generator 66 to a radiant syngas cooler (not shown) within gasifier 56 to facilitate cooling the syngas flowing within gasifier 56. Steam 72 is channeled through the radiant syngas cooler wherein water 72 is converted to steam 74. Steam 74 is then returned to steam generator 66 for use within gasifier 56 or steam turbine 58.

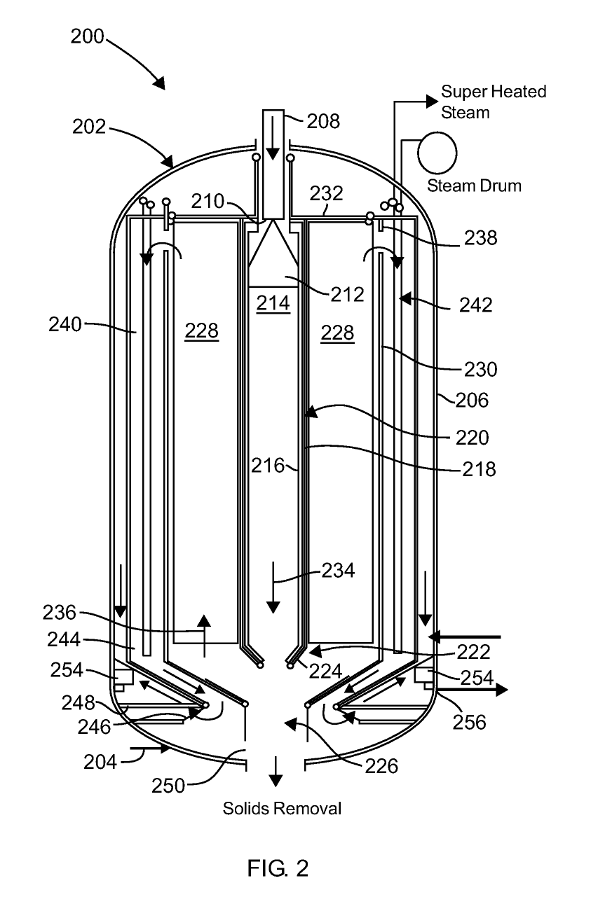

FIG. 2 is a schematic view of an exemplary advanced solids removal gasifier 200 that includes an integral radiant syngas cooler 300. Gasifier 200 may be used with a power system, such as system 50 (shown in FIG. 1). In the exemplary embodiment, gasifier 200 includes an upper shell 202, a lower shell 204, and a substantially cylindrical vessel body 206 extending therebetween. A feed injector 208 penetrates upper shell 202 to enable a flow of fuel to be channeled into gasifier 200. More specifically, the fuel flowing through injector 208 is routed through one or more passages 209 defined in feed injector 208 and is discharged through a nozzle 210 in a predetermined pattern 212 into a reaction zone 214 defined in gasifier 200. The fuel may be mixed with other substances prior to entering nozzle 210, and/or may be mixed with other substances when discharged from nozzle 210. For example, the fuel may be mixed with fines recovered from a process of system 50 prior to entering nozzle 210 and/or the fuel may be mixed with an oxidant, such as air or oxygen, at nozzle 210 or downstream from nozzle 210.

In the exemplary embodiment, reaction zone 214 is defined as a vertically oriented, generally cylindrical space that is substantially co-aligned with nozzle 210 in a serial flow communication. An outer periphery of reaction zone 214 is defined by a refractory wall 216 that includes a structural substrate, such as an Incoloy pipe 218 and a refractory coating 220 that substantially resists the effects of high temperatures and high pressures contained within reaction zone 214. In the exemplary embodiment, an outlet end 222 of refractory wall 216 includes a convergent outlet nozzle 224 that facilitates maintaining a predetermined backpressure in reaction zone 214, while permitting products of oxidation and syngas generated in reaction zone 214 to exit reaction zone 214. The products of oxidation may include gaseous byproducts, slag formed generally on refractory coating 220, and/or fine particular matter carried in suspension with the gaseous byproducts.

After exiting reaction zone 214, flowable slag and solid slag are gravity-fed into a lockhopper 226 coupled to bottom shell 204. Lockhopper 226 is maintained with a level of water that quenches the flowable slag into a brittle solid material that may be broken into smaller pieces when removed from gasifier 200. In the exemplary embodiment, lockhopper 226 captures approximately ninety percent of fine particulate exiting reaction zone 214.

In the exemplary embodiment, an annular passage 228 at least partially surrounds reaction zone 214. Passage 228 is partially defined by refractory wall 216 at an inner periphery, and by a cylindrical shell 230 that is substantially coaxially aligned with reaction zone 214 at a radially outer periphery of first passage 228. First passage 228 is sealed at the top by an upper flange 232. The gaseous byproducts and any remaining fine particulate are channeled from a downward direction 234 in reaction zone 214 to an upward direction 236 in passage 228. The rapid redirection at outlet nozzle 224 facilitates separating fine particulate and slag separation from gaseous byproducts.

The gaseous byproducts and any remaining fine particulate are channeled upward through passage 228 to an outlet 238. As the gaseous byproducts are channeled through passage 228, heat may be recovered from the gaseous byproducts and the fine particulate. For example, in one embodiment, the gaseous byproducts enter passage 228 at a temperature of approximately 2500° Fahrenheit and exit passage 228 at a temperature of approximately 1800° Fahrenheit. The gaseous byproducts and fine particulates are discharged from passage 228 through outlet 238 and are channeled into a second annular passage 240 wherein the gaseous byproducts and fine particulates are redirected to a downward flow direction 241. As gaseous byproducts and fine particulates flow through passage 240, heat may be recovered using for example, superheat tubes 242 that transfer heat from the flow of gaseous byproducts and the fine particulates to steam flowing through superheat tubes 242. For example, in one embodiment, the gaseous byproducts enter passage 240 at a temperature of approximately 1800° Fahrenheit and exit passage 240 at a temperature of approximately 1500° Fahrenheit.

When the flow of gaseous byproducts and the fine particulates reach a bottom end 244 of passage 240, passage 240 converges toward lockhopper 226. More specifically, at bottom end 244, the flow of gaseous byproducts and the fine particulates is channeled upward through a water spray 246 that desuperheats the flow of gaseous byproducts and the fine particulates. Heat removed from the flow of gaseous byproducts and the fine particulates tends to vaporize water spray 246 and agglomerate the fine particulates such that the fine particulates form a relatively larger ash clod that falls into lower shell 204. The flow of gaseous byproducts and the remaining fine particulates are channeled in a reverse direction towards a perforated plate 248 that circumscribes bottom end 244. A level of water is maintained above perforated plate 248 to facilitate removing additional fine particulate from the flow of gaseous byproducts. As the flow of gaseous byproducts and the remaining fine particulates percolate through perforated plate 248, fine particulates contained in the flow are entrapped in the water and carried through the perforations into a sump formed in bottom shell 204. A gap 250 defined between lockhopper 226 and bottom shell 204 enables the fine particulates to flow into lockhopper 226 wherein the fine particulates are facilitated to be removed from gasifier 200.

An entrainment separator 254 encircles an upper end of lower shell 204. More specifically, separator 254 is above perforated plate 248 and above the level of water covering perforated plate 248. Entrainment separator 254 may be for example, a cyclonic or centrifugal separator that includes a tangential inlet or turning vanes that impart a swirling motion to the gaseous byproducts and the remaining fine particulates flowing therethrough. The particulates are thrown outward by centrifugal force to the walls of separator 254 wherein the fine particulates coalesce and are gravity-fed to the separator bottom shell 204. Additionally, any remaining fine particulates impact a mesh pad, agglomerate with other particulates and are flushed to bottom shell 204.

Alternatively, entrainment separator 254 can be of a blade type, such as a chevron separator or an impingement separator. In a chevron separator, the gaseous byproducts pass between blades and are forced to travel in a tortuous or zigzag pattern. The entrained particulates and any liquid droplets cannot follow the gas streamlines, and impinge against the blade surfaces prior to coalescing, wherein the particulates are gravity-fed into bottom shell 204. Features such as hooks and pockets, can be added to the sides of the blades to facilitate improving particulate and liquid droplet capture. In addition, chevron grids can be stacked to provide a series of separation stages. Similarly, impingement separators create a cyclonic motion as gaseous byproducts and fine particulates pass over curved blades. A spinning motion is imparted that causes the entrained particulates and any liquid droplets to be forced against to the vessel walls, wherein the entrained particulates and any liquid droplets may be collected in bottom shell 204.

The flow of gaseous byproducts and any remaining fine particulates enter separator 254 wherein substantially all of any remaining entrained particulate and/or liquid droplets are removed form the flow of gaseous byproducts. The flow of gaseous byproducts exits gasifier 200 through an outlet 256 for further processing.

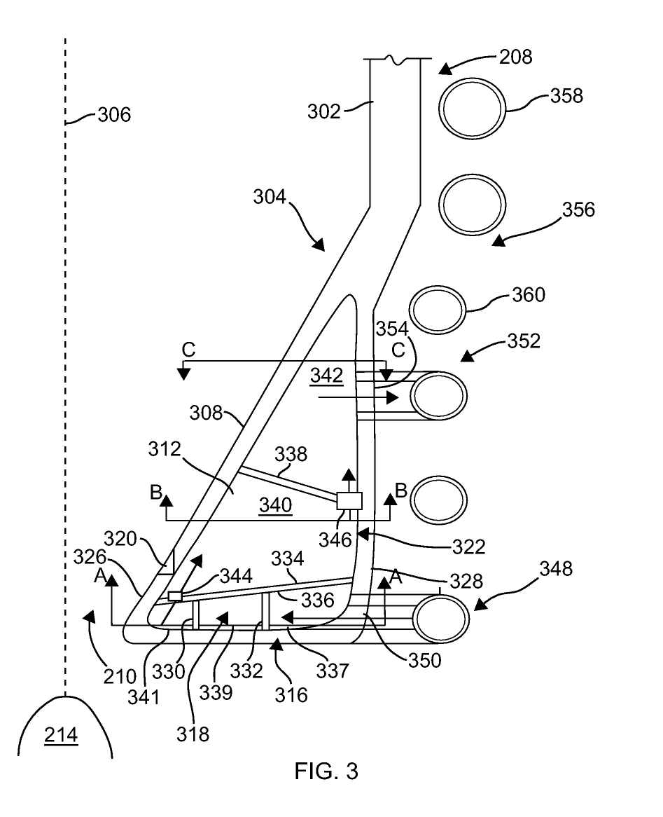

FIG. 3 is a side cross-sectional view of an exemplary embodiment of feed injector 208 (shown in FIG. 2). In the exemplary embodiment, feed injector 208 includes a substantially cylindrical conduit 302 and a convergent distal end 304 terminating at nozzle 210. Only a portion of feed injector is shown in FIG. 3 in two dimensions. The illustration in FIG. 3 is rotated about a longitudinal axis 306 to develop the three dimensional view of distal end 304. Distal end 304 includes a radially inner sidewall 308 that is convergent with respect to axis 306 and a diametrically opposed portion (not shown in FIG. 3) of sidewall 308. A radially outer sidewall 310 extends obliquely with respect to inner sidewall 308 to form a divergent annular channel 312 that extends circumferentially about distal end 304 proximate nozzle 210.

In the exemplary embodiment, channel 312 is enclosed at a distal opening 314 by an endcap 316 couplable to sidewalls 308 and 310 to form a first flow chamber 318 configured to channel a flow of coolant circumferentially about a distal end opening such as nozzle 210. In the exemplary embodiment, endcap 316 is coupled to sidewalls 308 and 310 at circumferential weldments 320 and 322. In an alternative embodiment, other coupling methods are used. Endcap 316 includes an endwall 324, a radially inner sidewall 326, and a radially outer sidewall 328. Each of sidewalls 326 and 328 are configured to mate to sidewalls 308 and 310, respectively for mating endcap 316 to distal end 304. Endcap 316 includes a radially inner dividing wall 330 and a radially outer dividing wall 332 that each extend substantially normally from endwall 324. Dividing walls 330 and 332 extend circumferentially about endwall 324. An annular top ring 334 is coupled to sidewalls 326 and 328 such that a surface 336 of top ring 334 mates with a distal end of dividing walls 330 and 332. The various sidewalls and caps described form a plurality of coolant passes 337 that extend circumferentially about distal end 304.

A second annular top cap 338 is coupled between sidewalls 308 and 310 to form a second flow chamber 340 axially-spaced from first flow chamber 318. A third axially-spaced flow chamber 342 is also formed between top cap 338 and sidewalls 308 and 310. The three flow chambers 318, 340 and 342 are in serial flow communication using a first flow port 344 formed in top ring 334 to permit a flow from first chamber 318 to second flow chamber 340 and a second flow port 346 formed in top cap 338 between second flow chamber 340 and third flow chamber 342.

A coolant inlet 348 is coupled to an inlet aperture 350 in sidewall 328 to permit an inflow of coolant into radially outer pass 337. In an alternative embodiment, coolant inlet 348 is coupled to radially inner pass 341. A coolant outlet 352 is coupled to an outlet aperture 354 through sidewall 310 such that coolant may flow from third flow chamber 342 into coolant outlet 352. In the exemplary embodiment, coolant is supplied to coolant inlet 348 through a cooling circuit 356 extending circumferentially about an outer periphery of injector 208. Cooling circuit 356 includes a plurality of turns of relatively large diameter piping 358 transitioning to a further plurality of turns of relatively smaller turns of cooling piping 360. Cooling circuit 356 circumscribes an outer periphery of feed injector 208 including at least a portion of substantially cylindrical conduit 302 and channel 312.

In operation, a flow of coolant is circulated through cooling circuit 356. At least a portion of the flow of coolant is channeled through coolant inlet 348 and into radially outer pass 337. The flow of coolant is channeled circumferentially through outer pass 337 and into next radially inner pass 339. The flow of coolant is channeled circumferentially through each radially inner pass in like manner until the flow of coolant reaches the innermost pass, in the exemplary embodiment, pass 341. The flow of coolant is then channeled through port 344 into second flow chamber 340. The flow of coolant is channeled circumferentially through second flow chamber 340 to port 346, where the flow of coolant is channeled into third flow chamber 342. The flow of coolant is channeled circumferentially through third flow chamber 342 to coolant outlet 352, where the flow of coolant is channeled into a coolant return portion of cooling circuit 356.

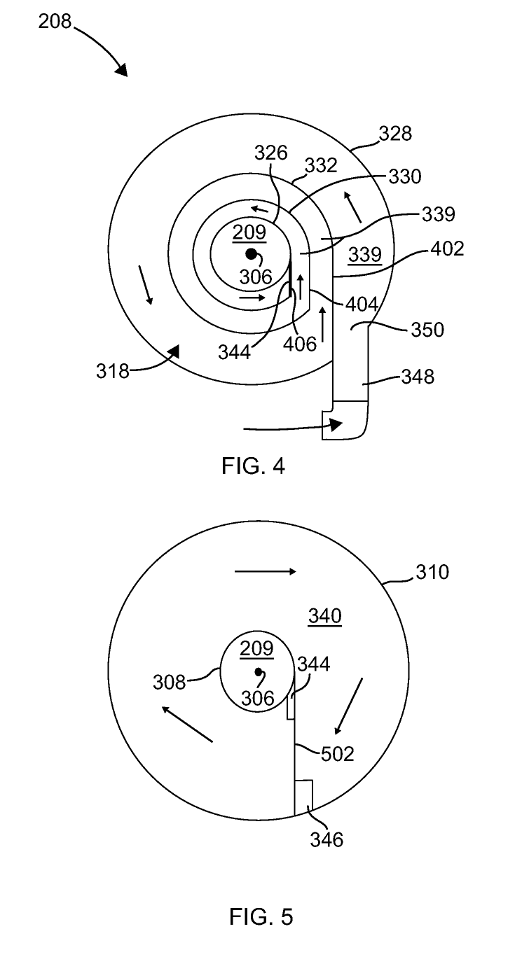

FIG. 4 is a plan view of feed injector 208 taken along line A-A (shown in FIG. 3). Feed injector 208 includes sidewalls 326 and 328 and dividing walls 330 and 332 arrangement substantially concentrically about axis 306. Dividing walls 330 and 332 do not completely circumscribe conduit 209, but rather include an opening to permit the flow of coolant to be channeled from a radially outer pass to a next radially inner pass to facilitate a spiral flow of coolant through first flow chamber 318. In the exemplary embodiment, flow chamber 318 is configured in a three-pass spiral using diverter walls that extend between adjacent sidewalls and dividing walls. A first diverter wall 402 is coupled between sidewall 328 and dividing wall 332 to channel flow from pass 337 to pass 339. A second diverter wall 404 is coupled between dividing wall 332 and dividing wall 330 to channel flow from pass 339 to pass 341. A third diverter wall 406 is coupled between dividing wall 330 and sidewall 326 to prevent short circuiting flow from pass 339 directly to port 344.

FIG. 5 is a plan view of feed injector 208 taken along line B-B (shown in FIG. 3). A diverter wall 502 is coupled between sidewall 310 and sidewall 308 to prevent short circuiting flow from port 344 directly to port 346.

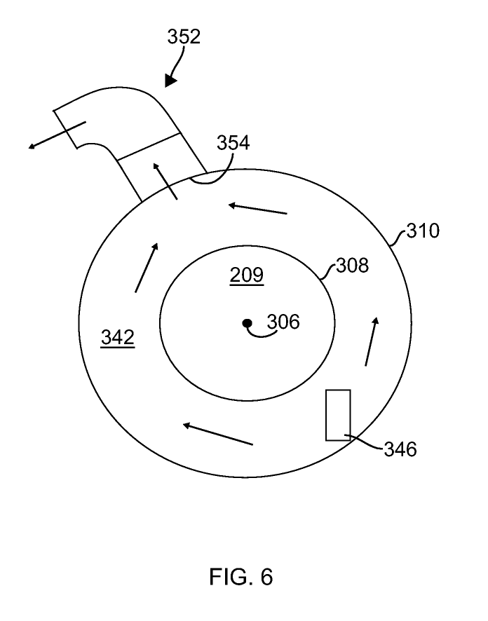

FIG. 6 is a plan view of feed injector 208 taken along line C-C (shown in FIG. 3). Third flow chamber 342 channels flow from port 346 to outlet 352.

The above-described methods and systems of cooling a gasifier feed injector are cost-effective and highly reliable. The methods and systems facilitate feed injector cooling using multiple cooling channel paths to provide the optimized cooling flow based on a location or the path from the reaction zone. The system includes a spiral path in the cooling channel near the feed injector tip bottom surface and the channel cross-sectional area increases in second and third layer channels to facilitate eliminating thinning of the injector walls and providing enhanced cooling. Accordingly, the above-described embodiments of the present invention facilitate operating partial oxidation systems in a cost-effective and reliable manner.

While embodiments of the disclosure have been described in terms of various specific embodiments, it will be recognized that the embodiments of the disclosure can be practiced with modification within the spirit and scope of the claims.

What is claimed is:

1. A feed injector comprising:
a conduit comprising a flow passage extending along a longitudinal axis of said conduit to a distal end opening; and
a cooling passage integral to the conduit circumscribing said distal end opening, said cooling passage configured to channel a flow of coolant circumferentially about said distal end opening, said cooling passage comprising a plurality of axially-spaced flow chambers.

2. A feed injector in accordance with claim 1 wherein said cooling passage is divergent in the direction of the passage toward the distal end opening.

3. A feed injector in accordance with claim 1 wherein said plurality of axially-spaced flow chambers comprises a first flow chamber circumscribing the distal end opening.

4. A feed injector in accordance with claim 3 wherein said first flow chamber comprises a plurality of axially-aligned radially-spaced flow passes.

5. A feed injector in accordance with claim 3 wherein a radially inner flow pass is coupled in flow communication with an axially-aligned radially outer flow pass.

6. A feed injector in accordance with claim 3 wherein said first flow chamber comprises a radially spiraling flow path through a plurality of axially-aligned radially-spaced flow passes.

7. A feed injector in accordance with claim 6 wherein said radially spiraling flow path comprises a radially outwardly spiraling flow path through a radially inner first flow pass adjacent said conduit through an adjacent radially outer second flow pass and through a radially outmost third flow pass.

8. A feed injector in accordance with claim 7 wherein a radially outermost flow pass is coupled in flow communication with an axially-spaced adjacent flow chamber.

9. A feed injector in accordance with claim 6 wherein said radially spiraling flow path comprises a radially inwardly spiraling flow path through a radially outmost first flow pass adjacent said conduit through an adjacent radially inner second flow pass and through a radially inner first flow pass.

10. A feed injector in accordance with claim 9 wherein a radially innermost flow pass is coupled in flow communication with an axially-spaced adjacent flow chamber.

11. A feed injector in accordance with claim 1 wherein said plurality of axially-spaced flow chambers comprises a second flow chamber axially adjacent said first flow chamber, said second flow chamber circumscribing said conduit.

12. A method of cooling an injector tip, said method comprising:
supplying a flow of coolant to a first flow chamber formed in the injector tip;
channeling the flow of coolant through a plurality of axially-aligned radially-spaced coolant passes formed in the first flow chamber; and
channeling the flow of coolant through an axially-spaced second flow chamber.

13. A method in accordance with claim 12 further comprising channeling the flow of coolant from the second flow chamber through an axially-spaced third flow chamber.

14. A method in accordance with claim 12 wherein channeling the flow of coolant through a plurality of axially-aligned radially-spaced coolant passes comprises channeling the flow of coolant wherein a cross-sectional area of each subsequent pass changes from the cross-sectional area of the previous pass.

15. A method in accordance with claim 12 wherein channeling the flow of coolant through an axially-spaced second flow chamber comprises channeling the flow of coolant wherein a cross-sectional area of the second flow chamber is different than the cross-sectional area of the first flow chamber.

16. A gasifier comprising:
a pressure vessel; and
a feed injector extending through said pressure vessel and comprising a nozzle tip at a distal end of said feed injector, said feed injector further comprising an integral cooling passage circumscribing said distal end opening, said cooling passage configured to channel a flow of coolant circumferentially about said distal end opening, said cooling passage comprising at least a first, a second, and a third axially-spaced flow chambers.

17. A gasifier in accordance with claim 16 wherein said first flow chamber comprises a plurality of axially-aligned radially-spaced flow passes.

18. A gasifier in accordance with claim 16 wherein a radially inner flow pass is coupled in flow communication with an axially-aligned radially outer flow pass.

19. A gasifier in accordance with claim 16 wherein said first flow chamber comprises a radially spiraling flow path through a plurality of axially-aligned radially-spaced flow passes.

20. A gasifier in accordance with claim 16 wherein said plurality of axially-spaced flow chambers comprises a second flow chamber axially adjacent said first flow chamber, said second flow chamber circumscribing said conduit.
